(19) United States
(12) Patent Application Publication
(10) Pub. No.: US 2018/0181676 A1
(43) Pub. Date: Jun. 28, 2018

(54) NODES IN DIRECTED ACYCLIC GRAPH

(71) Applicant: GOOGLE INC., Mountain View, CA (US)

(72) Inventors: Abhinav KHANDELWAL, Bangalore (IN); Dhyanesh DAMANIA, Bangalore (IN); Lakshit ARORA, Bangalore (IN); Mohit AGGARWAL, Faridabad (IN); Karthik KUMAR, Bangalore (IN)

(21) Appl. No.: 15/388,288

(22) Filed: Dec. 22, 2016

(51) Int. Cl. G06F 17/30

(52) U.S. Cl. CPC G06F 17/30958; G06F 17/30979

(57) ABSTRACT

Barrier node aggregation includes: in a directed acyclic graph in which each node is defined as either a barrier node or a non-barrier node, identifying, for a first barrier node, each descendant node that is a next barrier node to the first barrier node; and aggregating, at the first barrier node, information of each non-barrier node that is a descendant of the first barrier node and not separated therefrom by any identified next barrier node. Non-barrier node propagation includes: in a directed acyclic graph in which each node is defined as either a barrier node or a non-barrier node, identifying, for a first non-barrier node, each ancestor node that is a previous barrier node to the first non-barrier node; and propagating information of the first non-barrier node to each identified previous barrier node and to each non-barrier node between the first non-barrier node and the identified previous barrier node.

### TECHNICAL FIELD

This document relates, generally, to nodes in a directed acyclic graph.

### BACKGROUND

Graphs are used in computer systems to organize a collection of items or other entities, for example on a disk or in another form of storage. Such organization is sometimes done as a hierarchy of nodes, where items such as files are arranged to have defined ancestors and descendants. Aggregations are sometimes performed in such systems, for example from root to leaves, or from leaves to root. Examples of aggregations over a file system hierarchy involve aggregating counts of files and counts of folders in the hierarchy. Such systems can allow a user to query for, say, the number of images stored under a node in the hierarchy, or the number of bytes used by a particular sub-hierarchy on the disk.

In some existing systems, each node maintains an ancestor list that specifies, for that node, the name of all other nodes that are above the node in the hierarchy. In such systems, a query for information located at or below a particular node, can then be executed by searching for any node that has the particular node in its ancestor list. This can be considered a precomputation approach, in that the relationships are maintained by way of ancestor lists that must be kept up to date as the hierarchy changes. This approach can become inefficient or even impracticable when the hierarchy becomes deep, has a high fan-out degree, or simply when the hierarchy structure changes frequently. For example, a system based entirely on precomputation can suffer from latencies when the hierarchy is updated (e.g., when the contents change). On the other hand, an approach that uses only query time aggregation does not work on large ad complex hierarchies.

### SUMMARY

In a first aspect, a method of aggregation by a barrier node in a directed acyclic graph includes: in a directed acyclic graph in which each node is defined as either a barrier node or a non-barrier node, identifying, for a first barrier node, each descendant node that is a next barrier node to the first barrier node; and aggregating, at the first barrier node, information of each non-barrier node that is a descendant of the first barrier node and not separated therefrom by any identified next barrier node.

Implementations can include any or all of the following features. The method further includes creating a first list for the first barrier node, the first list identifying all descendant nodes of the first barrier node that are barrier nodes. The method further includes making the first list cumulative, so that if the first list of the first barrier node identifies a specific barrier node, then a corresponding first list for a barrier node above the first barrier node that contains the first barrier node, will also contain the specific barrier node. The method further includes detecting that a new relationship is being introduced in the directed acyclic graph, determining, using the first list, whether the new relationship is cyclic, and upon determining that the new relationship is cyclic, preventing the new relationship in the directed acyclic graph. The method further includes storing the first list at the first barrier node. The method further includes creating a second list for the first barrier node, the second list identifying all ancestor nodes of the first barrier node that are barrier nodes. The second list indicates which nodes have the first barrier node identified in their corresponding first list.

In a second aspect, a method of propagation by a non-barrier node in a directed acyclic graph includes: in a directed acyclic graph in which each node is defined as either a barrier node or a non-barrier node, identifying, for a first non-barrier node, each ancestor node that is a previous barrier node to the first non-barrier node; and propagating information of the first non-barrier node to each identified previous barrier node and to each non-barrier node between the first non-barrier node and the identified previous barrier node.

Implementations can include any or all of the following features. The method further includes creating a capped ancestor list for the first non-barrier node, the capped ancestor list identifying ancestor nodes to which the first non-barrier node propagates the information. The capped ancestor list is defined based on a current max ancestor value, the method further comprising setting the current max ancestor value based on how many parent nodes the first non-barrier node has in the directed acyclic graph. The method further includes creating a next barrier node list for the first non-barrier node, the next barrier node list identifying each descendant node that is a next barrier node to the first non-barrier node. The method further includes creating a previous barrier node list for the first non-barrier node, the previous barrier node list identifying each ancestor node that is the previous barrier node to the first non-barrier node, and using the previous barrier node list in the identification.

In a third aspect, a method includes: receiving a query for a directed acyclic graph in which each node is defined as either a barrier node or a non-barrier node, the received query relating to a first node and its descendants; determining, based on the received query: (i) a first aggregate stored at the first node, and (ii) a second aggregate stored at any descendant node of the first node that is a barrier node; and generating a response to the received query using the first and second aggregates.

Implementations can include any or all of the following features. The method further includes he first node is a first barrier node, the method further comprising using a list in determining the second aggregate, the list identifying, for the first barrier node, each descendant node that is a barrier node. Determining the second aggregate comprises identifying at least one descendant node on the list, and obtaining the second aggregate based on the identification. The first node is a first non-barrier node, the method further comprising using a list in determining the second aggregate, the list identifying, for the first non-barrier node, each descendant node that is a next barrier node to the first non-barrier node. Determining the second aggregate comprises identifying at least one descendant node on the list, and obtaining the second aggregate based on the identification. The identification and the obtention are performed using a single multiquery remote procedure call. The directed acyclic graph has multiple ways to reach a descendant node from of the first node, the method further comprising taking into account a multi-count aggregate in generating the response. Taking into account the multi-count aggregate comprises determining a number of paths between the first node and the descendant node. The method further includes including information of the descendant node multiple times in the first or second aggregate corresponding to the determined number of paths.

In a fourth aspect, a method includes: in a directed acyclic graph in which each node is defined as either a barrier node or a non-barrier node, defining a first node as a non-barrier node;

evaluating a barrier-node criterion for the first node; and upon determining that the barrier-node criterion is satisfied for the first node, defining the first node as a barrier node in the directed acyclic graph.

Implementations can include any or all of the following features. The first node has an ancestor list size corresponding to how many ancestors the first node has in the directed acyclic graph, and wherein the barrier-node criterion comprises that the ancestor list size is at least equal to a current max ancestor value for the first node, wherein the current max ancestor value depends on how many parent nodes the first node has in the directed acyclic graph. The first node has a current max ancestor value that depends on how many parent nodes the first node has in the directed acyclic graph, and wherein the barrier-node criterion comprises that the current max ancestor value is at least equal to a global max ancestor value for the directed acyclic graph. Multiple barrier-node criteria are evaluated, and wherein the first node is defined as a barrier node in the directed acyclic graph upon determining that any of the multiple barrier-node criteria is satisfied. A second node in the directed acyclic graph is defined as a barrier node, the method further comprising evaluating a non-barrier-node criterion for the second node, and upon determining that the non-barrier-node criterion is satisfied for the second node, defining the second node as a non-barrier node in the directed acyclic graph. The non-barrier-node criterion has at least one parameter in common with the barrier-node criterion, and wherein a threshold for the parameter is more stringent in the non-barrier-node criterion than in the barrier-node criterion. The method further includes taking into account at least one other signal about the directed acyclic graph in determining whether to define the first node as a barrier node. The other signal comprises a type of service by which a customer uses the directed acyclic graph. The other signal comprises a characteristic of how the directed acyclic graph is being used.

### BRIEF DESCRIPTION OF DRAWINGS

FIG. 1 shows an example of aggregation in a directed acyclic graph.

FIG. 2 shows an example of lists in a directed acyclic graph.

FIG. 3 schematically shows an example of using a Read Fan In list.

FIG. 4 schematically shows an example of computing aggregates under a barrier node.

FIG. 5 shows an example of a lookup flow.

FIG. 6 schematically shows an example of computing aggregates under a non-barrier node.

FIGS. 7A-D show examples of multi-counting aggregates.

FIG. 8 shows an example of evaluating a barrier-node criterion.

FIG. 9 shows another example of evaluating a barrier-node criterion.

FIG. 10 shows another example of evaluating a barrier-node criterion.

FIG. 11 shows an example of aggregating indexes in a directed acyclic graph.

FIG. 12 shows an example of cycle prevention in a directed acyclic graph.

FIG. 13 shows an example of a computer device and a mobile computer device that can be used to implement the techniques described here.

### DETAILED DESCRIPTION

This document describes examples of maintaining information in a directed acyclic graph of nodes, and querying such a graph for particular information. In some implementation, the propagation of node information is organized so that certain nodes aggregate information propagated to them from their descendant nodes, but they do not propagate that information further up in the graph. Rather, the aggregated information is accessible for querying without having to be further propagated in the graph. Other nodes, by contrast, do propagate their information upward, including information that they aggregated from descendant nodes. As such, it may then not be necessary to access that individual node when its information has been aggregated elsewhere. Some implementations can provide an advantageous flexibility in querying by employing a combination of precomputation and query time computation. This can allow the manager of the system to implement the desired balance between the efficiency of answering aggregation queries and the amount of latency introduced when the graph is updated.

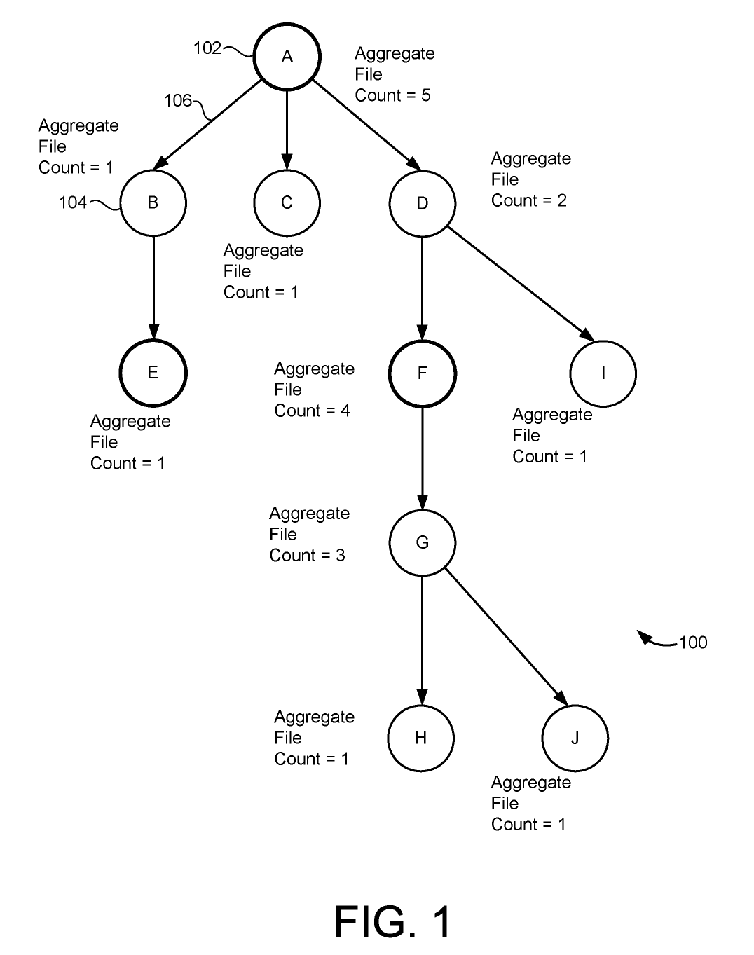

FIG. 1 shows an example of aggregation in a directed acyclic graph (DAG) 100. Here, the DAG includes two types of nodes, schematically represented as circles. The circles are labeled with the letters A through J for identification. One node type 102 is indicated by a thicker line and is here referred to as a barrier node (BN). In this example, nodes A, E and F are BNs. Another node type 104 is indicated by a les thick line and is here referred to as a non-barrier node (NBN). Here, nodes B, C, D, G, H, I and J are NBNs. Relationships are indicated by edges 106 between pairs of nodes. For example, the edge 106 indicates that the node A is a parent of the node B.

A BN can store the precomputed aggregations of a subtree under it, up to some depth from the BN, but does not propagate it further up in the graph. If the BN cannot store the aggregation of the entire subtree underneath the BN, it can store a list of one or more BNs that are below it. Accordingly, the aggregations of the lower BN(s) need to be read to compute the statistics of the entire subtree under the first BN. The BNs therefore provide that an aggregate query which is to be performed on any node can be served by reading the aggregate stored at that node, as well as the aggregate(s) stored at any BN(s) that is a descendant node of the queried node. In some implementations, the term BN signifies that the BN acts as a barrier against upward propagation of information of that node, both its own information and information it has aggregated from nodes below. For example, the BN can preclude any upward propagation, of information updates as well as aggregations.

An NBN can aggregate information from a subtree under it, and also propagate the aggregate information upward to the nearest BN(s). The NBN can store a list of ancestors—that is, nodes above it from which it has a direct or indirect dependency—until the point of the nearest BN(s) above it in the hierarchy. The NBN can therefore propagate its information upward until the nearest BN(s).

Starting at the bottom of the DAG 100, the node J is here indicates as having an aggregate file count of one. For example, the node J represents a single file in the DAG 100. Similarly, the node H represents another single file, and so does the node G. The node G is here the parent of the nodes H and J, and G therefore aggregates the information of the nodes H and J. That is, the aggregate file count for the node G is the sum of the individual file counts for node G (one file), node H (one file) and node J (one file), or 1+1+1=3. Because the node G is an NBN, it propagates its information upward to the nearest BN(s). Here, only the node F (e.g., a single file) is a nearest BN to the node. Accordingly, the aggregate file count for the node F is its individual count (one), plus the aggregate count (three) received from the node G.

Because the node F is a BN, it does not propagate its information upward to the node D (its parent) or to any other node. The node D therefore does not aggregate any information from the node F. The node I, on the other hand, is an NBN and therefore propagates its information to the node D, as well as to the node A above D, because node A is a BN. Accordingly, the node D here receives a file count of one from the node I and accumulates that into an aggregate file count of two for the node D. The aggregate file count for the node A, in turn, is here five, because it receives the aggregate of two from the node D and individual counts of one from each of the nodes B and C. The node E, by contrast, is a BN and therefore does not propagate its information up to the node B (its parent).

In short, the DAG 100 illustrates the following relationships. Nodes B, C, D and I are NBNs and each of them will propagate its information (e.g., a file count) to the node A. Nodes E and F, on the other hand, are BNs and as such will not propagate any information upward. Nodes G, H and J, finally, will propagate information to the node F but not further than that.

Accordingly, one or more methods of aggregation can be performed in a directed acyclic graph in which each node is defined as either a BN or an NBN, for example the DAG 100. Such a method can include identifying, for a first BN, each descendant node that is a next BN to the first BN. As an example, for the node A there can be identified the BNs E and F. The nodes E and F are each a next BN to the node A because they are not separated from node A by any other BN. The method can include aggregating, at the first BN, information of each NBN that is a descendant of the first BN and not separated therefrom by any identified next BN. For example, at the node A can be aggregated information of the nodes B, C, D and I, each of which is an NBN.

Such a method can include identifying, for a first NBN, each ancestor node that is a previous BN to the first NBN. As an example, for the node H the ancestor node F can be identified as a previous BN. The node A, by contrast, is not a previous BN to the node H because another BN is between them, namely node F. The method can include propagating information of the first NBN to each identified previous BN and to each NBN between the first NBN and the identified previous BN. For example, the information of node H can be propagated to the node F (i.e., here the previous BN) and to the node G, which is here an NBN between nodes H and F.

Examples of calculating a file count in the DAG 100 will now be given. Suppose that a query seeks the count of files under the node A. Based on the DAG 100, the system will obtain information about node A's own aggregate file count, and the aggregate file count of any BNs under node A. Here, the latter includes the aggregate file counts under the nodes E and F, which are BNs. That is, the file count under node A is determined by adding A's aggregate file count (here, five), E's aggregate file count (here, one) and F's aggregate file count (here, four), for a total of ten files.

Suppose instead that the query sought the file count under node D, which is an NBN. Similarly to the above example, this is determined by obtaining the aggregate stored at D (here, two) and the aggregate stored at node F (here, four), which is node D's only descendant BN. The aggregate file count under D is therefore 2+4=6. Note that the query needed not explicitly probe node I in this example, because this is an NBN that is a child node of the node being queried, and as such its count has been aggregated at its parent, node D.

As a final example, assume that the query sought the file count under the node G, which is also an NBN. Here, node G has no BN below it. As such, the system will read G's aggregate file count (here, three) and that is the response to the query in this example.

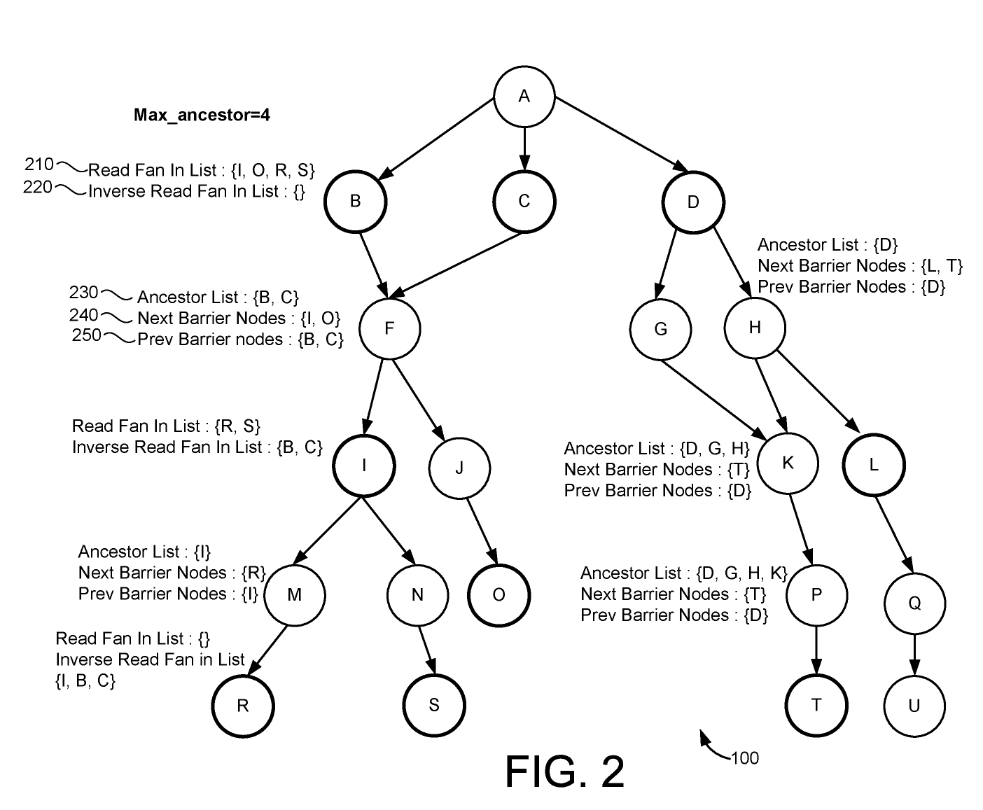

Aggregation of information and querying of aggregate information can be performed using one or more lists. FIG. 2 shows an example of lists in a directed acyclic graph 200. Although the structure of this exemplary DAG is different from the one in the previous figure, the nomenclature used is similar, for simplicity. Thus, BNs are indicated by thicker lines, NBNs by thinner lines, and the nodes are labeled A-D and F-U, respectively. Thus, the NBNs are here nodes A, F, G, H, J, K, M, N, P, Q and U, and the BNs are nodes B, C, D, I, L, O, R, S and T. The illustrated nodes can be part of a larger graph. Thus, more BNs and/or NBNs can exist than are visible in this illustration. In some implementations, the root node of a graph is always a BN. The lists can be stored in any suitable location, such as at the respective node to which they belong, or at another place.

In some implementations, BNs have different lists than NBNs. Here, each BN (such as the node B) has a read fan in list (RFI) 210 and an inverse read fan in list (I-RFI) 220. For clarity, the RFIs and I-RFIs are explicitly shown only for some of the nodes. Examples of these lists will be described, but it is noted that the BNs here do not include complete lists of their ancestors.

Beginning with the RFI, this is a list of all descendant nodes of the BN which are themselves BNs. For example, the RFI of node B here contains the names of nodes I, O, R and S, which are the descendants of node B that are BNs. When a query is received that seeks information about a subtree under a particular node, in this example node B, the system will fan in the aggregate information from the nodes identified in the RFI. This is part of the information needed to compute the total aggregate under the node B.

Thus, a list such as the RFI can be created for a BN that identifies all its descendant nodes that are BNs. The RFI can be cumulative. In some implementations, if the RFI of, say, node B mentions the node I, then all BNs above B (not shown in the figure) will also contain the node I in their respective RFIs. For example, this can provide the advantage that at query time the system does not spend too much time determining the nodes from which aggregates need to be fanned in.

In mathematical terms, the RFI can be expressed in terms of a Read_Fan_In function as follows:

Let ∃ a barrier node X at depth M from a root. Then Read_Fan_{—In(}X)=Read_Fan_In(Y)∀Y at depth M+n(k(Y)+1), n≥0

Thus, the RFI of a node X can be the union of the RFIs of nodes at depths below X. In terms of an induction, this can be expressed as:

Read_Fan_In(X)=∪(Read_Fan_In(Y)∪Y)∀Y at depth M+n(k(Y)+1), n≥0

Moreover, the RFIs can have fewer entries toward the bottom of the DAG 200. For example, node B's RFI is {I,O,R,S}, whereas node I's RFI is only {R,S} and node R's RFI, finally, is empty.

The I-RFI 220, in turn, will be used when updating the graph, and includes all the ancestor nodes that are BNs. As noted earlier, the RFI can be cumulative, so any update (e.g., to a list) needs to be propagated to the respective RFIs of the ancestors. Therefore, the I-RFI can be an inverse mapping to determine which nodes need updating. For example, having the I-RFI can reduce the write time cost without affecting correctness and efficiency of aggregations at query time.

Here, the I-RFI 220 of the node R is {I,B,C}. This indicates which of the nodes in the DAG 200 have the node R in their respective RFIs. This list can be considered an inverse mapping. In a sense, the I-RFI contains the names of BNs up from the current node, all the way to the root. The I-RFI can be empty if the corresponding BN is not a part of a specifically designated root folder for this particular user. In some implementations, this is the only situation where the I-FRI list would be empty.

The I-RFI can be cumulative. Mathematically, the I-RFI can be expressed in terms of a function I_RFI thus:

$${I}_{—} RFI ( X ) = ⋃ {I}_{—} RFI ( Y ) ∀ Y at depth M - n ( k ( Y ) + 1 ) , n \geq 0 and n \leq \frac{M}{K ( Y )} + 1$$

In terms of an induction, this can be expressed as:

$${I}_{—} RFI ( X ) = ⋃ ( {I}_{—} RFI ( Y ) ⋃ Y ) ∀ Y at depth M - n ( k ( Y ) + 1 ) , n \geq 0 and n \leq \frac{M}{K ( Y )} + 1$$

Thus, the I-RFI can grow in size toward the bottom of the DAG 200. For example, the I-RFI of the node B is empty, the I-RFI of the node I is {B,C} and the I-RFI of the node R is {I,B,C}.

Thus, the I-RFI can be a list that identifies all ancestor nodes of a BN that are themselves BNs. For example, the I-RFI can indicate, for a given BN, which BNs above have that BN in their respective RFI.

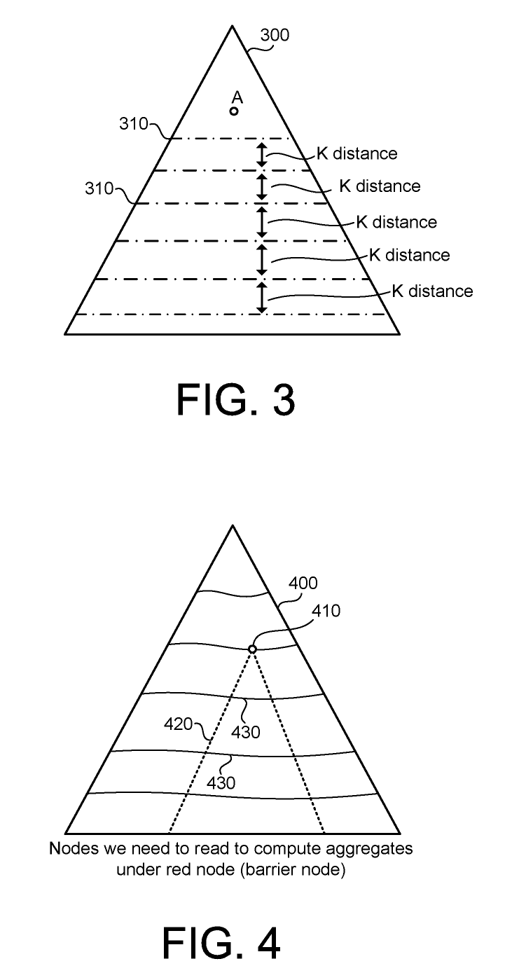

FIG. 3 schematically shows an example of using a Read Fan In list. DAG 300 is an example if a graph having a structure of nodes. For simplicity only a single node A is here shown, schematically represented as a circle. Here, node A is a BN, and BNs below the node A are schematically represented by horizontal lines 310 across the DAG. The separation between adjacent ones of the lines 310 is here exemplified as “K distance,” illustrating that BNs can be defined at regular intervals in a hierarchy. Each of the BNs represented by the lines 310 can have its corresponding RFI. If the RFI is a cumulative list, then all nodes' information can be considered as stored at the node A.

One or more lists can be used in an NBN. Referring again to FIG. 2 and the DAG 200, each NBN (e.g., the node F) can have an ancestor list 230, a next BN list 240, and a previous BN list 250. The ancestor list can be a capped ancestor list that contains some or all of the ancestors of a given node. In some implementations, the ancestor list specifies the ancestors to which a node should propagate its information. For example, this can be all nodes up to, and including, the nearest BN along each path of ancestry.

For example, the ancestor list 230 of the node F is here {B,C}, indicating that the node F propagates its information to those nodes. For the node M, by contrast, the ancestor list is {I}, indicating that the node M, which is an NBN, propagates information to the node I. The node M does not propagate information to the nodes above node I, however, because the node I is a BN. Accordingly, a capped ancestor list can be created for an NBN, the capped ancestor list identifying ancestor nodes to which the NBN propagates information.

The capping can be specified in form of a number. In some implementations, the capping is flexible. For example, the capping can change when a new parent node is added for the particular node. Assume that parents are added to a given node in the DAG, this cap can be increased by some amount that is here referred to as Δ. For example, if the node has only one parent node, its size will be Δ. On the other hand, if the node has n parent nodes its size will be n*Δ. This can be the maximum size that the node can accommodate. The value n*Δ can, at any point, be known as a variable current_max_ancestor. For example, this can signify that some nodes should be taken from each ancestor path and the system should not give priority to a single long path, assuming that merging of ancestor paths is relatively uncommon.

A variable global_max_ancestor can be defined. In some implementations, this represents the limit that a cap cannot exceed. For example, this variable can be fixed in the system. As a result,

current_max_ancestor(n*Δ)<global_max_ancestor

where n is the number of parents (or ancestor paths coming into this node).

In addition to the variables current max ancestor and global_max_ancestor discussed above, the actual ancestor list size also exists for each NBN. The relation between them for an NBN can be expressed as:

ancestor list size<current_max_ancestor(n*Δ)<global_max_ancestor

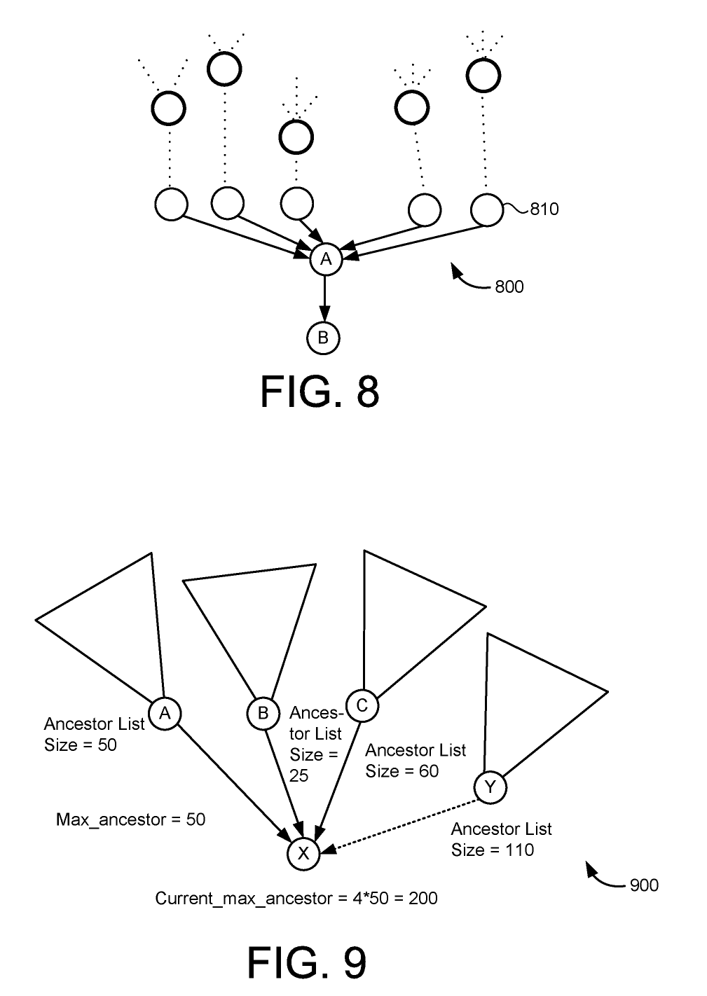

That is, the ancestor list 230 is an example of a capped ancestor list defined based on a current max ancestor value, and that value can be set based on how many parent nodes the NBN has in the DAG. Examples of caps are described below with reference to FIGS. 8-10.

The next BN list 240 contains nodes that are the nearest descendants of the node that are also BNs, for all hierarchies below the node. For example, the next BN list 240 of the node F is {I,O}. In contrast, the nodes R and S, which are also BNs, are not on the list 240 because the node I is a BN that is closer to the node F in the paths than they are. On the other hand, for the node M the next BN list is simply {R}. In some implementations, the next BN list is used at query time. Thus, the list 240 is an example of creating a next BN list for an NBN, the list identifying each descendant node that is a next BN for the NBN.

The previous BN list 250 can contain nodes that are the nearest BN ancestors of an NBN, along all ancestor paths. For example, for the node M the previous BN list includes only {I}, as this is the nearest BN upward from the node M. The nodes B and C, by contrast, are not the nearest BNs of M because the node I is nearer to M in their paths. As another example, for the node P the previous BN list includes the node D. In some implementations, the previous BN list 250 is used during updates. Thus, the list 250 is an example of creating a previous BN list for an NBN, the list identifying each ancestor node that is the previous BN for the NBN, and that such a list can be used in identifying the ancestor nodes to which the NBN should propagate its information.

In some implementations, the RFI 210 and the I-RFI 220 that are present in the BNS, and the next BN list 240 and the previous BN list 250 that are present in NBNs, can be considered as similar concepts, with a difference being that the former lists are cumulative and the latter ones only contain the nearest respective node. Mathematically this can be expressed as

X.NearestNextBNList⊂Y.RFI where Y is one of the BN ancestors of X

Similarly

X.NearestPreviousBNList⊂Y. I_RFI where Y is one of the BN descendants of X

For example, in the DAG 200, the node P has an ancestor list of {D, G, H, K}, and it does not have the node A in that list. The reason is that the node P will propagate its information upward until it hits a BN. Here, the node P finds the node D that is a BN and P therefore does not propagate the information any further. Therefore, the node A is not in the ancestor list of the node P.

It has been mentioned above that the approach of using BNs and NBNs can be used in situations when the graph is to be queried for information. For example, and without limitation, the query can relate to a count of nodes, or files or folders, or it can be a search for a particular item, such as an image. Generally, a query can be received for a DAG, the received query relating to a particular node and its descendants. Based on the received query a system can determine an aggregate stored at the particular node itself, and an aggregate stored at any descendant node of the particular node that is a BN. A response to the received query can these be generated using these aggregates.

A query relating to a BN and its descendants can be performed in two steps. Step 1 can be formulated as: <N.aggregated value, N.readjan in list>, which signifies that aggregates stored at the node N and at its read_aggregation_list are fetched. For a relatively deep hierarchy it may be necessary to perform step 2: For each node in the read_fan_in_list, fetch the aggregate value(s) stored at that node, and then aggregate these values with the value(s) fetched in step 1.

FIG. 4 schematically shows an example of computing aggregates under a barrier node. Similar to earlier illustrations, this figure represents BNs using heavier lines and NBNs using thinner ones. In a DAG 400 a BN 410 is schematically represented. The query seeks information about nodes in a subtree 420, where lines 430 represent the respective BN descendants of the BN 410. In step 1 mentioned above, aggregates and the RFI stored at the node 410 are read. The RFI gives the BN descendants of the node 410. In step 2 mentioned above, aggregates stored at the descendant BNs (represented by the lines 430) are read. That is, this illustrates the nodes for which aggregates should be computed in this example query. The above is an example of using a list in determining an aggregate, the list identifying, for the BN, each descendant node that is a BN. The above also exemplifies that determining an aggregate can include identifying at least one descendant node on the list, and obtaining the aggregate based on the identification.

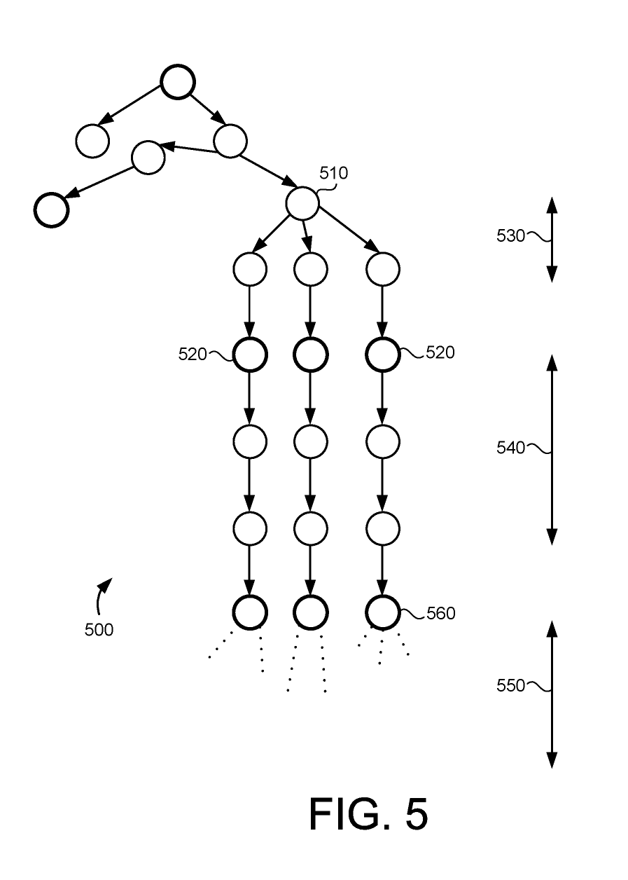

FIG. 5 shows an example of a lookup flow. Here, a DAG 500 includes BNs shown in heavier lines and NBNs shown in thinner lines. In performing a query regarding an NBN 510, the system first reads the aggregate stored at that node. That aggregate is of the NBNs below that node, until the first level of BNs. The node 510, moreover, will have its nearest BN descendants 520 identified in its RFI. Aggregates will therefore be read from them. Accordingly, levels 530, 540 and 550 can be defined in the DAG 500. The level 530 is where the aggregation of information is covered by reading the aggregation stored at the node 510. The level 540 is where the aggregation of information is covered by reading aggregations stored at the BNs 520. The level 550, moreover, is where the aggregation of information will be covered by reading aggregation(s) at one or more lower BNs 560.

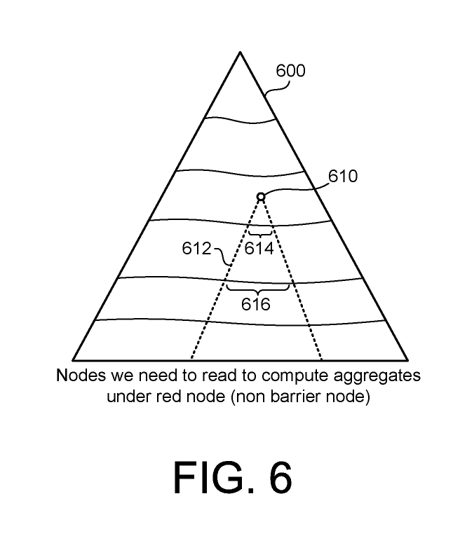

FIG. 6 schematically shows an example of computing aggregates under a non-barrier node. In a DAG 600 node 610 is an NBN and the query seeks information about nodes in a subtree 612. In a first step, aggregates and next BNs can be read from the node 610. In a second step, aggregates and RFI lists are read from the nearest BNs, as identified by the RFI. The nearest BNs are here schematically indicated as a line 614. In a third step, aggregates can be read from all nodes present in the RFI fetched in the second step. This process can conclude if finished, or if more layers of the DAG remain to be queried, then the process can continue with one or more additional iterations.

Accordingly, a list such as a next BN list can be used in determining an aggregate for an NBN, namely in that the list identifies each descendant node that is a next BN to the NBN. For example, a descendant node can be identified on the list, and the aggregate can be obtained based on that identification. In some implementations, a remote procedure call (RPC) can be used by the system. For example, a single multiquery RPC can be used for both identifying the nodes and obtaining the aggregates.

Some DAGs can be very complex, have many layers and/or a high fan-out degree. For example, there can be more than one path that connects two nodes to each other. In such or other situations, multi-counting of paths and/or nodes can be performed. In some implementations, multi-counting requires storing of the number of paths between a parent node and its descendant node. For example, the count of the number of pathways can be added to one or more lists, such as the RFI or the ancestor list. If multi-counting is required, the system can add the particular value of the field to the filed a corresponding number of times. Otherwise, the count can be ignored and the filed be added only once. Accordingly, a multi-count aggregate can be taken into account in generating a query response. For example, the multi-count aggregate can include that the number of paths between a node and its descendant node is determined. When multi-counting should be taken into account, information about the descendant node can be included multiple times in aggregate information corresponding to the number of paths that was determined.

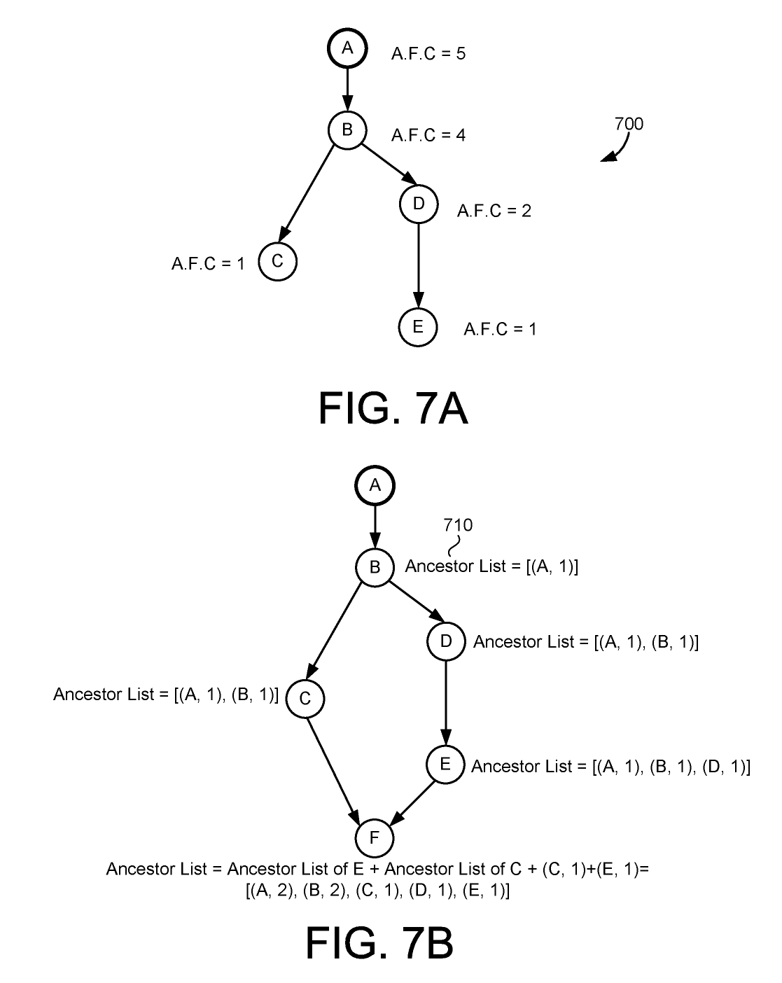

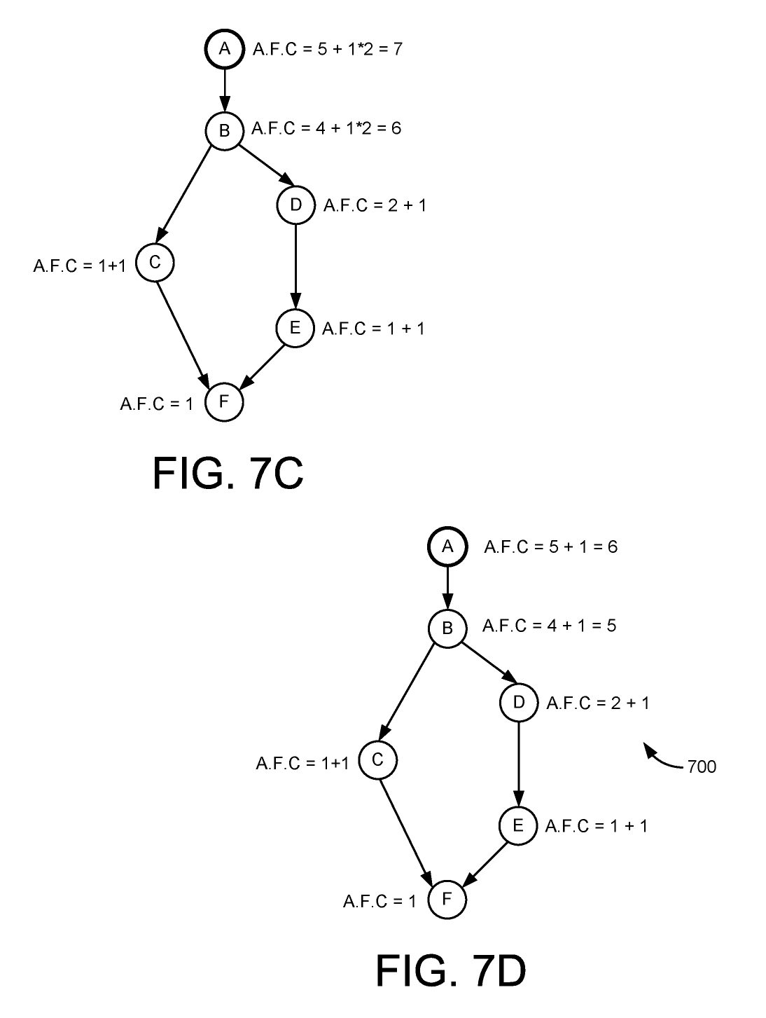

FIGS. 7A-D show examples of multi-counting aggregates. FIG. 7A shows a DAG 700 with a node A that is a BN, and nodes B, C D and E that are NBNs. Here, the node C forms one branch under the node B, and the nodes D and E form another branch. The aggregation can relate to any node information, including, but not limited to, an aggregate file count (here A.F.C). This figure shows the state of the aggregate file count before a new node is added to the DAG. For example, node B here receives a count of one from the node C and an aggregate count of 3 from the nodes D and E. Together with B's own count of one, this forms an aggregate count of four at the node B.

Assume now that a node is added to the DAG 700. FIG. 7B shows the state after a node F is added, the new node having both nodes C and E as parents. In particular, the figure shows the ancestor lists for the respective nodes. Node B has an ancestor list 710 that includes [(A,1)]. The value A can signify that the only ancestor of this node is node A, and the value 1 can signify that there is only one path between nodes B and A. Similarly, node C has an ancestor list of [(A,1), (B,1)], which indicates that nodes A and B are both ancestors of node C, and that there is only one path to each of them.

The node F, however, has an ancestor list that facilitates multi-counting. Here, the ancestor list of node F is the sum of the ancestor lists of nodes C and E, because F has each of these nodes as a parent, plus one connection each for the node F's respective connections to the nodes C and E. The ancestor list of the node F is therefore [(A,2), (B,2), (C,1), (D,1), (E,1)]. That is, the node F has two paths to the node A, two paths to the node B, and one path to each of the nodes C, D and E.

FIG. 7C shows the effect on the aggregate file counts as a result of adding the node F. The node F itself has a file count of one. Because the node F is an NBN, this number is propagated upward to the next BN and to the intervening NBN(s). Here, nodes B, C, D and E are NBNs and receive the additional count from the node F. Accordingly, node C is now at two for example. The node B, moreover, gets an additional file count contribution from both the C-node branch and from the D-E-node branch, for an extra two counts. Accordingly, the aggregate file count at the node B increases from four to six. Similarly, the node A also receives a double counting of the contribution of the node F and therefore increase its count by two from five to seven.

Assume now instead that multi-counting were disabled. FIG. 7D shows the DAG 700 with the respective aggregate file counts indicated for each node. There is no difference for the nodes C, D E and F compared to before. For nodes B and A, on the other hand, the contribution of the new node F is no longer counted multiple times. Accordingly, the node B has a count of one added, for a new total aggregate file count of five. Similarly, the node A has one count added for a total of six.

In some implementations, the count can also be stored in an RFI. For example, because BNs do not propagate anything upward, this can facilitate multi-counting in form of multiplication of the aggregate value read from the BN by the count read from the RFI.

DAGs have been exemplified herein that have each node classified as being either a BN or an NBN, and in the above example that classification did not change for any of the nodes during the described session. Generally, BN can serve an important role in a DAG in driving the amount of cost for the system based on BNs and NBNs. That cost is measured both in form of query time and the amount of precomputation storage. For example, if a DAG has a large number of BNs, this reduces the demand for resources and improves the performance when the graph is updated, because changes need not be propagated beyond the nearest BNs. However, these improvements can come at the expense of query time performance degradation, because the system may need to look up multiple BNs to answer the query. On the other hand, if the system has fewer BNs, then latency issue can appear when updates are made, and the need for resources can be greater. However, the lesser number of BNs can improve query time performance because there are fewer BN lookups before answering the query. It can therefore be helpful to flexibly be able to control the balance of BNs versus NBNs in the graph, for example to optimize the above factors depending on the current situation.

Therefore, in some implementation one or more nodes that are already classified as a BN or an NBN can be reclassified as another node type. In some implementations, the approach can be to make a node a BN when it becomes too costly to propagate the aggregation upward in the hierarchy. For example, this can be the case when a node has many parent nodes in the graph. The transition can be done dynamically, such as by evaluation of one or more criteria. For example, one or more signal used by an aggregation system (e.g., a folder aggregation in a drive) can be used when deciding which nodes should be BNs and when to make a transition from BN to NBN or vice versa.

In some implementations, the system is configured so that a node should be defined as a BN when the following condition no longer holds

Ancestor list size<current_max_ancestor(k*max _ancestor)<global_max_ancestor

where k is the number of parents. It is seen that the condition contains two inequalities indicated by respective “is less than” symbols. For example, if either inequality is no longer met, the condition can be deemed to no longer hold.

FIG. 8 shows an example of evaluating a barrier-node criterion. Here, a DAG 800 includes BNs and NBNs along the lines of earlier examples herein. Particularly, nodes A and B. both of which are NBNs, are labeled.

Assume in this example that the following values have been defined max_ancestor=10

global_max_ancestor=100

Here, the node A has five parent nodes 810. Because A has five parent nodes, the current_max_ancestor value for A is 5*max_ancestor=5*10=50. That is, the node A will contain ancestors to which it will propagate its value (e.g., to the first BNs it encounters along all its ancestor paths). Assume that there are 45 such ancestors. When the node B is added as a child of the node A, some new values can be calculated. B takes over the ancestor list of node A, so that B's ancestor list contains the 45 ancestors of the node A, plus A itself; thus 45+1=46.

But because the node B has only one parent node, the current_max_ancestor is 1*max_ancestor=1*10=10. That is, B currently has 46 ancestors which exceeds the maximum value of ten. The criterion for being a barrier node can therefore be met, and the system can redefine B as a BN.

In some implementations, a criterion can be applied for BN-to-NBN redefinition, or for NBN-to-BN redefinition, or both. For example, this can involve performing a method in a graph such as the DAG 800. The method can include defining a node as an NBN, and evaluating a BN criterion for the node. Upon determining that the BN criterion is satisfied, the method can include defining the node as a BN in the DAG.

FIG. 9 shows another example of evaluating a barrier-node criterion. Here, a DAG 900 includes a node X, and respective parent nodes A, B, C and Y are then added to the node X. The addition of a parent node can occur by way of introducing new nodes into the DAG 800 such that they have a parent-child relationship to the node X. As another example, a new parent-child edge can be created between node X and an existing node in the graph.

In this example, the Max ancestor value has been set to 50. Moreover, the new parent nodes have ancestor lists that add the following numbers to X's ancestry: A's list is 50, B's list is 25, C's list is 60 and D's list is 110. When the node A is added as a parent node to the node X, X gains one parent. Node X's current max ancestor value therefore becomes 1*50=50. Moreover, the cumulative impact of A and its ancestor list on B's ancestor list is a count of 50. This is allowed by the current max ancestor value, and X therefore copies node A's ancestors into its list.

When node B is added as a parent of node X, X's current max ancestor value becomes 50+50=100. However, B's total impact on the number of ancestors for X is only 25 as mentioned above. Node X will therefore add these 25 to its ancestor list. That is, the current_max_ancestor value is 100, but X currently has an ancestor list of only 75.

When node C is added as a parent of node X, X's current_max_ancestor value becomes 150 (due to having three parents). Node C, moreover, adds a count of 60 to X's list of ancestors. Node X's ancestor list therefore becomes 75+60=135.

Node Y, on the other hand, has a relatively large ancestor list. When node Y is added as a parent of node X, X's current_max_ancestor value increases by 50 and becomes 200. Moreover, adding the 110 ancestors, contributed by the node Y, to the existing 135 ancestors of node X would cause node X to have 245 ancestors. This would exceed the current_max_ancestor value of 200. Therefore, the system can redefined node X as a BN upon node Y being added as a parent.

In some implementations, a BN can be create to avoid having too much aggregate propagation higher up in the hierarchy, such that it makes sense to stop the propagation at the point where a new node, or a new edge, is created. Moreover, the addition of parent nodes can occur in a different order than described above. For example, if the node Y had been added as a parent of node X before the nodes A, B and C, then the BN criterion would have been satisfied already at that point. Accordingly, node X could have been redefined as a BN earlier than in the previous example.

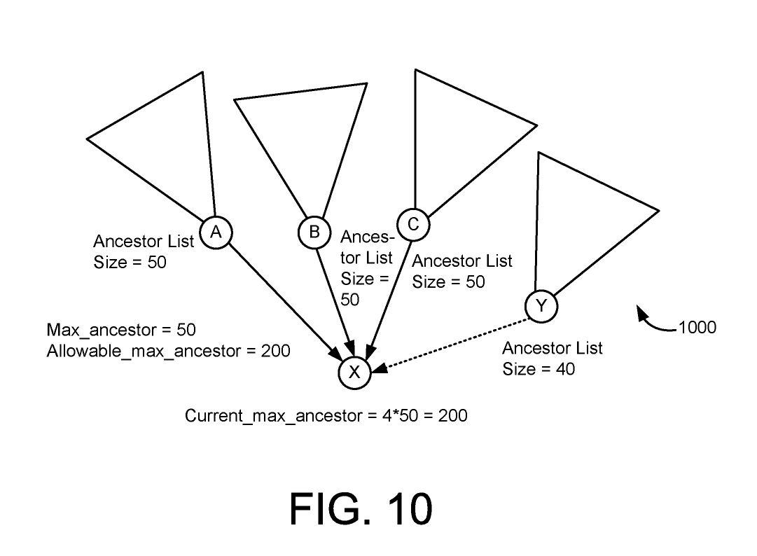

In the above example, the BN condition no longer held because the actual number of ancestors grew too large. In other situations, the condition can be deemed to no longer hold because the potential number of ancestors grows too large, regardless of the actual number of ancestors. Such an example will be described next. FIG. 10 shows another example of evaluating a barrier-node criterion. Similar to the previous example, a DAG 1000 has a node X therein, and parent nodes A, B, C and Y are to be added to node X. Also, the max_ancestor value is 50, and an allowable_max_ancestor value has been set to 200. The ancestor lists of the nodes A, B, C and Y are different from the previous example, however, so that they here contribute to the node X's ancestry list, respective counts of 50, 50, 50 and 40 ancestors.

Thus, when node A is added as a parent of node X, X's current_max_ancestor value becomes 50. When node B is added as a parent of node X, X's current_max_ancestor value becomes 100, and when node C is added as a parent of node X, X's current_max_ancestor value becomes 150. Finally, when node Y is added as a parent of node X, X's current_max_ancestor value becomes 200. However, this value is the same as the allowable_max_ancestor value of 200. The inequality that current_max_ancestor should be less than allowable_max_ancestor therefore no longer holds. It can thus be determined that X should be redefined as a BN.

In some implementations, multiple BN criteria can be evaluated, such as the dual inequality mentioned above, and if any of the is satisfied, the node can be redefined. For example, the criterion can include that that an ancestor list size is at least equal to a current max ancestor value for the node. As another example, the criterion can include that a current max ancestor value is at least equal to a global max ancestor value.

The above examples involved potentially redefining an NBN as a BN. In some implementations, a BN can be redefined as an NBN. For example, due to a hierarchy update, such as removal of a large parent hierarchy) the node can be better suited as an NBN. This can be determined using at least an estimated number of ancestors. In some implementations, a BN does not have an ancestor list, but the size of its potential ancestor list can be computed using the sizes of its parents' ancestor lists. In some implementations, a different criterion can be used than one for NBN-to-BN redefinition. In some implementations, the following condition can be used

2*(Ancestor list size)<current_max_ancestor(k*max _ancestor)<(global_max_ancestor)/2

For example, this can seek to ensure that there are not too many transitions back and forth from BN to NBN, and from NBN to BN. Accordingly, such a criterion can involve a threshold that is more stringent than a corresponding one for the other criterion.

In some implementations, one or more signals can be used to trigger a transition between BN and NBN. It can sometimes be preferable to serve aggregate queries, and search queries, faster for some users than for others. For example, this can depend on the level of service that the user is provided with such that certain users are paying a premium in return for a more advanced or faster implementation. Another user, in turn, could receive a discounted or free service in return for a reduced amount of resources being used in serving the queries and maintaining the hierarchies. Some implementations can balance resource usage and query time performance for aggregations and searching in deep, large and/or frequently updated DAGs based on a graph priority. For example, if a graph is of higher priority the queries can be served relatively fast, and if the graph is of lesser priority the system can trade off query time performance against resource savings.

The balance of the number of BNs to the number of NBNs can affect the above characteristics. Examples of signals that can be used in determining how to strike the balance between them include, but are not limited to: the identity of the customer to whom the file-folder hierarchy belongs, such as, the level of service accessible to the customer; and the hierarchy behavior, such as that a hierarchy that is updated frequently should have relatively more BNs, whereas a hierarchy that is queried frequently the number of BNs can be kept to a relatively lower number.

Some examples above have involved aggregations of file counts under respective nodes in a DAG. Other information about nodes can also or instead be queried. In some implementations, efficient searching in a DAG can be provided. Searching over a hierarchy can be defined as searching for all nodes in the hierarchy that satisfy a certain condition. For example, a query can correspond to the request “Show me all images inside this folder which are accessible to me” or “Show me all files inside this folder that match a certain pattern, such as ‘*.pdf’ (i.e., a wildcard expression for pdf files).” Using BNs and NBNs, such searching can be efficiently performed also in DAGs that are deep, have high fan-out degree, and/or when the hierarchy structure changes frequently.

With regard to searching, a BN can store precomputed search metadata of a subtree under it, up to some depth. That is, the BN may or may not store the search metadata of the whole subtree. If the BN cannot store all search metadata of the entire subtree below it, it can store the list of BNs below it, because those BNs' metadata should be read to compute the statistics of the entire subtree under the node. As a BN, the node does not propagate the search metadata above itself, but rather all search metadata below it is rolled up to the BN only. An NBN, in contrast, can store the list of ancestors above it until it reaches the first BN in its hierarchy (e.g., in each path upward). It can thus propagate its search metadata up until the BN(s). That is, instead of aggregating values as in other examples herein, certain implementations can aggregate indexes upward in a hierarchy until finding the BN(s).

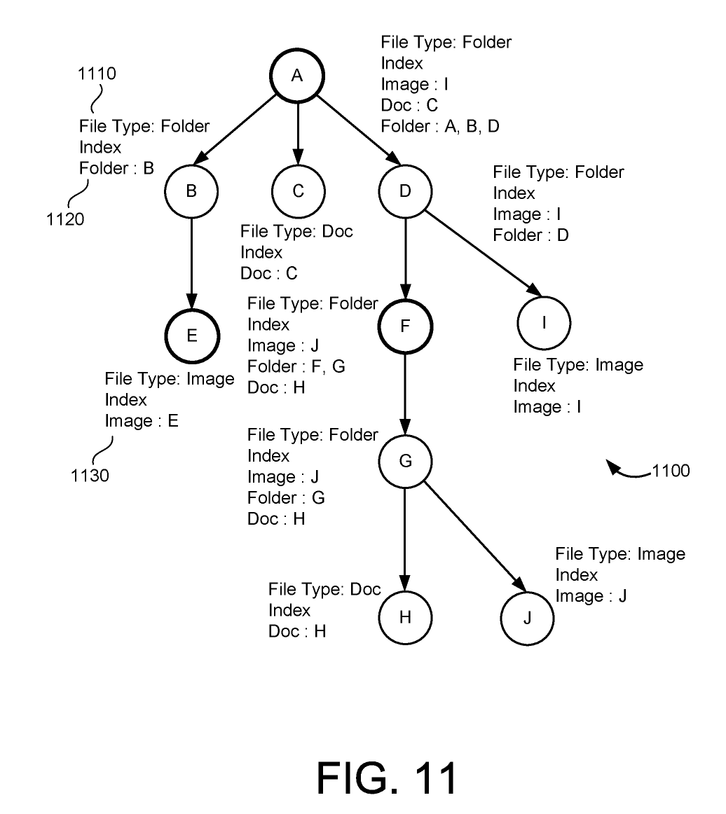

FIG. 11 shows an example of aggregating indexes in a DAG 1100. Here, nodes A through J are shown. Nodes A, E and F are BNs, and nodes B, C, D, G, H, I and J are NBNs. Each node can include some information. A file type field 1110 indicates what type of file the node is associated with. For example, the node B has the file type “folder”, the node E has the file type “image”, and the node H has the type document (“Doc”). A folder field 1120 indicates whether the node aggregates one or more folders and, if so, the name(s) of the folder(s). For example, the folder field for the node B contains “B”, the folder field for the node F contains “F,G” because is the BN for the node G which is a folder, and the node E—which is an image, not a folder—does not have a folder field. An image field 1130, moreover, indicates the name of the image(s), if any, aggregated by the node. For example, the image field for the node A contains “I” because the node I here corresponds to an image. The node J, in contrast, which is also an image, is not identified in node A's image field, because node J is aggregated under another BN, namely node F. That is, the image field of node F contains the entry “J”, because node J is here the only image aggregated to the node F.

Consider now a situation where the user wishes to show all the images together and all the documents together. Being NBNs. the nodes B, C, D and I will aggregate their indices to the node A, which is a BN. The nodes E and F are BNs and therefore will not propagate their indices upward. The nodes G, H and J, finally, are NBNs and thus will propagate their indices to the node F, a BN, and not beyond there. Assume for example that the query seeks all images under the node A. This can mathematically be expressed as querying for

TypeIndex_{A}[image]∪TypeIndex_{E}[image]∪TypeIndex_{F}[image]

That is, the query focuses on the nodes A, E and F, each of which is a BN. Here, nodes I, E and J are images that fit the above criteria. Accordingly, these images can be the result of the search.

Assume as another example that all images under node D are sought. This can mathematically be expressed as querying for

TypeIndex_{D}[image]∪TypeIndex_{F}[image]

That is, the query focuses on the node D, which is an NBN, and the BN below it, node F. Here, nodes I and J are images that fit the above criteria. Accordingly, these images can be the result of the search.

Assume as another example that all images under node G are sought. This can mathematically be expressed as querying for

TypeIndex_{G}[image]

That is, the query focuses on the node G, which is an NBN that does not have any BN below it. Here, node J is an image that fits the above criterion. Accordingly, this image can be the result of the search.

In some situations, the formation of a cycle during an edge addition in a tree or DAG can be undesirable. Examples can include adding a folder as a child of its own child folder in a file system. A system that expects to perform real time cycle detection when an edge is added may not work for large or complex hierarchies. Om the other hand, a system that seeks to precompute any potential cycles could suffer from update latencies.

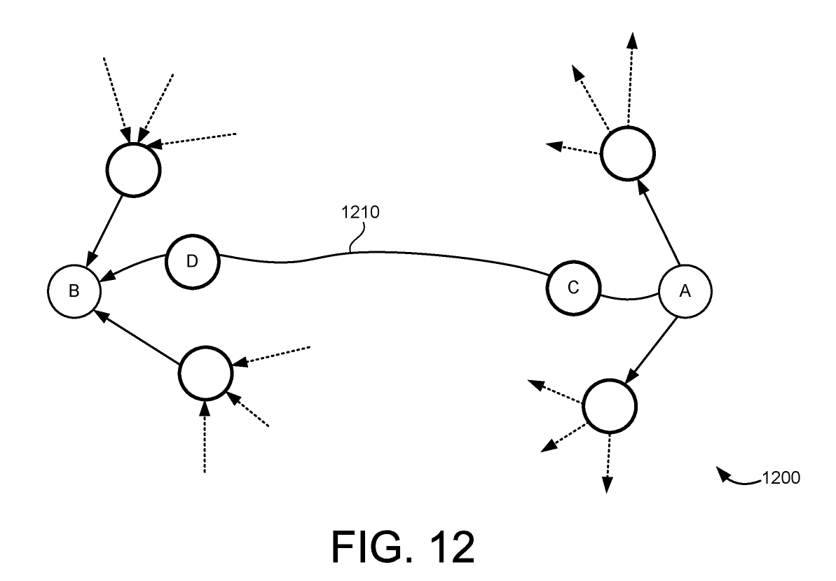

An approach involving BNs and NBNs can provide efficient cycle prevention. FIG. 12 shows an example of cycle prevention in a DAG 1200. The DAG 1200 includes a number of nodes, only some of which are shown, for simplicity. Nodes A, B, C and D have been labeled. Nodes A and B are NBNs, and nodes C and D are BNs.

Assume now that a user tries to create an edge 1210 from node B to node A. If node A is already an ancestor of node B, it may be possible in many (or most) cases to find node A already present in the ancestor list of node B. For example, keeping the capping of ancestor lists sufficiently large can seek to ensure this. However, in other cases node A is not in the ancestor list of node A, yet node A is an ancestor of node B. In such situations, the system can look up one or more BNs on the path(s) joining nodes A and B.

Here, on the edge 1210 connecting nodes A and B, node C is the nearest BN descendant of node A, and node D is the nearest BN ancestor of node B. As shown, there can be more than one BN between A and B. Moreover, if A is itself a BN then one can consider C=A for these purposes, and similarly for node B.

If A is an ancestor node of node B, then the following should be satisfied, assuming that nodes C and D are different:

{D}∈C's Read Fan In list

That is, C's RFI should contain the node D, since the RFI is cumulative and therefore stores all BN descendants. It may therefore follow that
I f A is an ancestor of B, then 3 at least two barrier nodes C and D:
1. C:C is one of the next barrier nodes of A
2. D:D is one of the previous barrier nodes of B
such that:
{D} ∈ C. Read Fan In List or C=D

Therefore, if A is an ancestor of B, then one of the following should hold:

A ∈ B. Ancestor List

or

{D} ∈ C. Read Fan In List

or

C=D

As such, the creation of a cycle in the DAG can be detected, and therefore prevented if necessary. A method can include detecting that a new relationship is being introduced in the DAG, and determining whether the new relationship is cyclic. For example, a RFI can be used. Upon determining that the new relationship is cyclic, the new relationship can be prevented in the DAG.

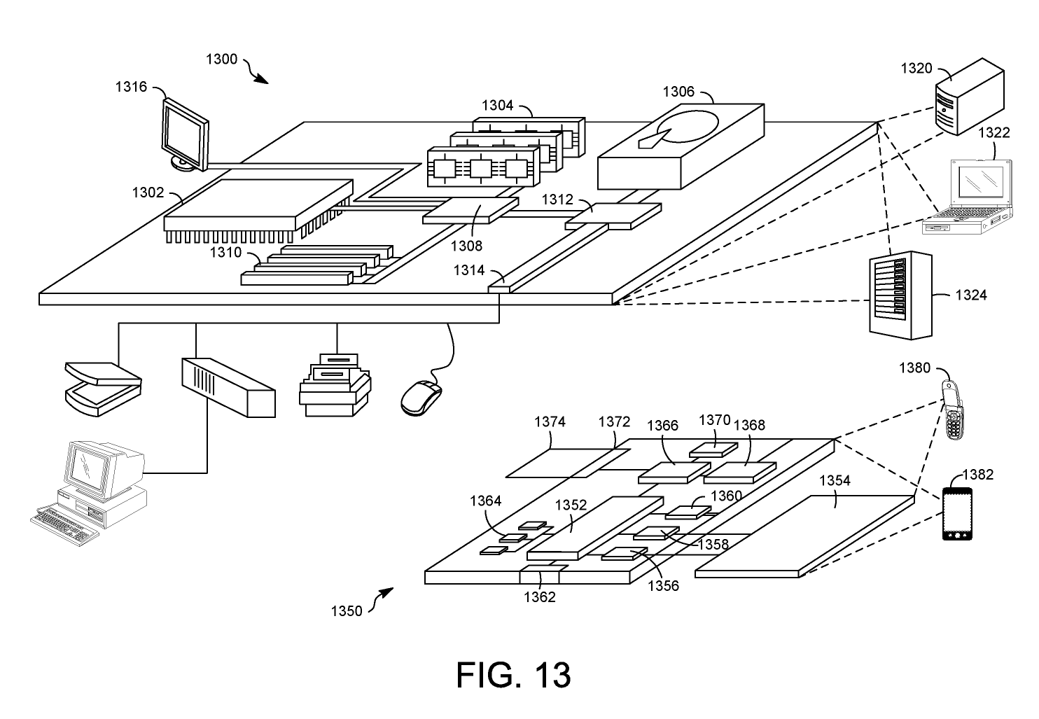

FIG. 13 shows an example of a generic computer device 1300 and a generic mobile computer device 1350, which may be used with the techniques described here. Computing device 1300 is intended to represent various forms of digital computers, such as laptops, desktops, tablets, workstations, personal digital assistants, televisions, servers, blade servers, mainframes, and other appropriate computing devices. Computing device 1350 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1300 includes a processor 1302, memory 1304, a storage device 1306, a high-speed interface 1308 connecting to memory 1304 and high-speed expansion ports 1310, and a low speed interface 1312 connecting to low speed bus 1314 and storage device 1306. The processor 1302 can be a semiconductor-based processor. The memory 1304 can be a semiconductor-based memory. Each of the components 1302, 1304, 1306, 1308, 1310, and 1312, are interconnected using various busses, and may be mounted on a common motherboard or in other manners as appropriate. The processor 1302 can process instructions for execution within the computing device 1300, including instructions stored in the memory 1304 or on the storage device 1306 to display graphical information for a GUI on an external input/output device, such as display 1316 coupled to high speed interface 1308. In other implementations, multiple processors and/or multiple buses may be used, as appropriate, along with multiple memories and types of memory. Also, multiple computing devices 1300 may be connected, with each device providing portions of the necessary operations (e.g., as a server bank, a group of blade servers, or a multi-processor system).

The memory 1304 stores information within the computing device 1300. In one implementation, the memory 1304 is a volatile memory unit or units. In another implementation, the memory 1304 is a non-volatile memory unit or units. The memory 1304 may also be another form of computer-readable medium, such as a magnetic or optical disk.

The storage device 1306 is capable of providing mass storage for the computing device 1300. In one implementation, the storage device 1306 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1304, the storage device 1306, or memory on processor 1302.

The high speed controller 1308 manages bandwidth-intensive operations for the computing device 1300, while the low speed controller 1312 manages lower bandwidth-intensive operations. Such allocation of functions is exemplary only. In one implementation, the high-speed controller 1308 is coupled to memory 1304, display 1316 (e.g., through a graphics processor or accelerator), and to high-speed expansion ports 1310, which may accept various expansion cards (not shown). In the implementation, low-speed controller 1312 is coupled to storage device 1306 and low-speed expansion port 1314. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1300 may be implemented in a number of different forms, as shown in the figure. For example, it may be implemented as a standard server 1320, or multiple times in a group of such servers. It may also be implemented as part of a rack server system 1324. In addition, it may be implemented in a personal computer such as a laptop computer 1322. Alternatively, components from computing device 1300 may be combined with other components in a mobile device (not shown), such as device 1350. Each of such devices may contain one or more of computing device 1300, 1350, and an entire system may be made up of multiple computing devices 1300, 1350 communicating with each other.

Computing device 1350 includes a processor 1352, memory 1364, an input/output device such as a display 1354, a communication interface 1366, and a transceiver 1368, among other components. The device 1350 may also be provided with a storage device, such as a microdrive or other device, to provide additional storage. Each of the components 1350, 1352, 1364, 1354, 1366, and 1368, are interconnected using various buses, and several of the components may be mounted on a common motherboard or in other manners as appropriate.

The processor 1352 can execute instructions within the computing device 1350, including instructions stored in the memory 1364. The processor may be implemented as a chipset of chips that include separate and multiple analog and digital processors. The processor may provide, for example, for coordination of the other components of the device 1350, such as control of user interfaces, applications run by device 1350, and wireless communication by device 1350.

Processor 1352 may communicate with a user through control interface 1358 and display interface 1356 coupled to a display 1354. The display 1354 may be, for example, a TFT LCD (Thin-Film-Transistor Liquid Crystal Display) or an OLED (Organic Light Emitting Diode) display, or other appropriate display technology. The display interface 1356 may comprise appropriate circuitry for driving the display 1354 to present graphical and other information to a user. The control interface 1358 may receive commands from a user and convert them for submission to the processor 1352. In addition, an external interface 1362 may be provide in communication with processor 1352, so as to enable near area communication of device 1350 with other devices. External interface 1362 may provide, for example, for wired communication in some implementations, or for wireless communication in other implementations, and multiple interfaces may also be used.

The memory 1364 stores information within the computing device 1350. The memory 1364 can be implemented as one or more of a computer-readable medium or media, a volatile memory unit or units, or a non-volatile memory unit or units. Expansion memory 1374 may also be provided and connected to device 1350 through expansion interface 1372, which may include, for example, a SIMM (Single In Line Memory Module) card interface. Such expansion memory 1374 may provide extra storage space for device 1350, or may also store applications or other information for device 1350. Specifically, expansion memory 1374 may include instructions to carry out or supplement the processes described above, and may include secure information also. Thus, for example, expansion memory 1374 may be provide as a security module for device 1350, and may be programmed with instructions that permit secure use of device 1350. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1364, expansion memory 1374, or memory on processor 1352, that may be received, for example, over transceiver 1368 or external interface 1362.

Device 1350 may communicate wirelessly through communication interface 1366, which may include digital signal processing circuitry where necessary. Communication interface 1366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1368. In addition, short-range communication may occur, such as using a Bluetooth, WiFi, or other such transceiver (not shown). In addition, GPS (Global Positioning System) receiver module 1370 may provide additional navigation- and location-related wireless data to device 1350, which may be used as appropriate by applications running on device 1350.

Device 1350 may also communicate audibly using audio codec 1360, which may receive spoken information from a user and convert it to usable digital information. Audio codec 1360 may likewise generate audible sound for a user, such as through a speaker, e.g., in a handset of device 1350. Such sound may include sound from voice telephone calls, may include recorded sound (e.g., voice messages, music files, etc.) and may also include sound generated by applications operating on device 1350.

The computing device 1350 may be implemented in a number of different forms, as shown in the figure. For example, it may be implemented as a cellular telephone 1380. It may also be implemented as part of a smart phone 1382, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A method of aggregation by a barrier node in a directed acyclic graph, the method comprising:
in a directed acyclic graph in which each node is defined as either a barrier node or a non-barrier node, identifying, for a first barrier node, each descendant node that is a next barrier node to the first barrier node; and
aggregating, at the first barrier node, information of each non-barrier node that is a descendant of the first barrier node and not separated therefrom by any identified next barrier node.

2. The method of claim 1, further comprising creating a first list for the first barrier node, the first list identifying all descendant nodes of the first barrier node that are barrier nodes.

3. The method of claim 2, further comprising making the first list cumulative, so that if the first list of the first barrier node identifies a specific barrier node, then a corresponding first list for a barrier node above the first barrier node that contains the first barrier node, will also contain the specific barrier node.

4. The method of claim 2, further comprising detecting that a new relationship is being introduced in the directed acyclic graph, determining, using the first list, whether the new relationship is cyclic, and upon determining that the new relationship is cyclic, preventing the new relationship in the directed acyclic graph.

5. The method of claim 2, further comprising storing the first list at the first barrier node.

6. The method of claim 2, further comprising creating a second list for the first barrier node, the second list identifying all ancestor nodes of the first barrier node that are barrier nodes.

7. The method of claim 6, wherein the second list indicates which nodes have the first barrier node identified in their corresponding first list.

8. A method of propagation by a non-barrier node in a directed acyclic graph, the method comprising:
in a directed acyclic graph in which each node is defined as either a barrier node or a non-barrier node, identifying, for a first non-barrier node, each ancestor node that is a previous barrier node to the first non-barrier node; and
propagating information of the first non-barrier node to each identified previous barrier node and to each non-barrier node between the first non-barrier node and the identified previous barrier node.

9. The method of claim 8, further comprising creating a capped ancestor list for the first non-barrier node, the capped ancestor list identifying ancestor nodes to which the first non-barrier node propagates the information.

10. The method of claim 9, wherein the capped ancestor list is defined based on a current max ancestor value, the method further comprising setting the current max ancestor value based on how many parent nodes the first non-barrier node has in the directed acyclic graph.

11. The method of claim 8, further comprising creating a next barrier node list for the first non-barrier node, the next barrier node list identifying each descendant node that is a next barrier node to the first non-barrier node.

12. The method of claim 8, further comprising creating a previous barrier node list for the first non-barrier node, the previous barrier node list identifying each ancestor node that is the previous barrier node to the first non-barrier node, and using the previous barrier node list in the identification.

13. A method comprising:
receiving a query for a directed acyclic graph in which each node is defined as either a barrier node or a non-barrier node, the received query relating to a first node and its descendants;
determining, based on the received query: (i) a first aggregate stored at the first node, and (ii) a second aggregate stored at any descendant node of the first node that is a barrier node; and
generating a response to the received query using the first and second aggregates.

14. The method of claim 13, wherein the first node is a first barrier node, the method further comprising using a list in determining the second aggregate, the list identifying, for the first barrier node, each descendant node that is a barrier node.

15. The method of claim 14, wherein determining the second aggregate comprises identifying at least one descendant node on the list, and obtaining the second aggregate based on the identification.

16. The method of claim 13, wherein the first node is a first non-barrier node, the method further comprising using a list in determining the second aggregate, the list identifying, for the first non-barrier node, each descendant node that is a next barrier node to the first non-barrier node.

17. The method of claim 16, wherein determining the second aggregate comprises identifying at least one descendant node on the list, and obtaining the second aggregate based on the identification.

18. The method of claim 17, wherein the identification and the obtention are performed using a single multiquery remote procedure call.

19. The method of claim 13, wherein the directed acyclic graph has multiple ways to reach a descendant node from of the first node, the method further comprising taking into account a multi-count aggregate in generating the response.

20. The method of claim 19, wherein taking into account the multi-count aggregate comprises determining a number of paths between the first node and the descendant node.

21. The method of claim 20, further comprising including information of the descendant node multiple times in the first or second aggregate corresponding to the determined number of paths.

22. A method comprising:
in a directed acyclic graph in which each node is defined as either a barrier node or a non-barrier node, defining a first node as a non-barrier node;
evaluating a barrier-node criterion for the first node; and
upon determining that the barrier-node criterion is satisfied for the first node, defining the first node as a barrier node in the directed acyclic graph.

23. The method of claim 22, wherein the first node has an ancestor list size corresponding to how many ancestors the first node has in the directed acyclic graph, and wherein the barrier-node criterion comprises that the ancestor list size is at least equal to a current max ancestor value for the first node, wherein the current max ancestor value depends on how many parent nodes the first node has in the directed acyclic graph.

24. The method of claim 22, wherein the first node has a current max ancestor value that depends on how many parent nodes the first node has in the directed acyclic graph, and wherein the barrier-node criterion comprises that the current max ancestor value is at least equal to a global max ancestor value for the directed acyclic graph.

25. The method of claim 22, wherein multiple barrier-node criteria are evaluated, and wherein the first node is defined as a barrier node in the directed acyclic graph upon determining that any of the multiple barrier-node criteria is satisfied.

26. The method of claim 22, wherein a second node in the directed acyclic graph is defined as a barrier node, the method further comprising evaluating a non-barrier-node criterion for the second node, and upon determining that the non-barrier-node criterion is satisfied for the second node, defining the second node as a non-barrier node in the directed acyclic graph.

27. The method of claim 26, wherein the non-barrier-node criterion has at least one parameter in common with the barrier-node criterion, and wherein a threshold for the parameter is more stringent in the non-barrier-node criterion than in the barrier-node criterion.

28. The method of claim 22, further comprising taking into account at least one other signal about the directed acyclic graph in determining whether to define the first node as a barrier node.

29. The method of claim 28, wherein the other signal comprises a type of service by which a customer uses the directed acyclic graph.

30. The method of claim 28, wherein the other signal comprises a characteristic of how the directed acyclic graph is being used.
